(19) United States
(12) Patent Application Publication
(10) Pub. No.: US 2015/0069890 A1
(43) Pub. Date: Mar. 12, 2015

(54) Children's Furniture

(71) Applicant: Katherine Messervy Jenkins, Denver, NC (US)

(72) Inventor: Katherine Messervy Jenkins, Denver, NC (US)

(21) Appl. No.: 14/481,316

(22) Filed: Sep. 9, 2014

Related U.S. Application Data
(60) Provisional application No. 61/875,909, filed on Sep. 10, 2013.

(51) Int. Cl. A47B 61/00; H01R 25/00; A47B 61/04

(52) U.S. Cl. CPC A47B 61/003; A47B 61/04; H01R 25/006
USPC 312/237; 439/652

(57) ABSTRACT

Children's furniture for organizing clothing and accessories is described herein. The furniture, a Valet System, is shaped in the form of a young boy or young girl. The Valet System comprises a plurality of devices for holding or storing clothing and accessories such as notched bars, clips, drawers, and cabinets.

### CROSS-REFERENCE TO RELATED APPLICATIONS

The present application claims the benefit to U.S. Provisional Patent Application No. 61/875,909, filed Sep. 10, 2013, which is hereby incorporated by reference as though fully set forth herein.

### BACKGROUND

The present disclosure is generally related to furniture. More particularly, the present disclosure is directed to children's furniture such as furniture for storing and organizing shirts, dresses, shorts, pants, skirts, shoes, accessories, and other items.

Most items of children's furniture are box-like storage bins and standard dressers having a box-like shape. Although the furniture can be painted in various aesthetically pleasing colors, there has not been innovation over the years in terms of how items are stored and displayed.

### BRIEF SUMMARY

It is an object of the present invention to provide an item of furniture which has an improved aesthetic appearance and provides greater interest to a user of the same.

Disclosed herein is a system for organizing children's clothes, shoes, accessories, etc. referred to herein as a “Valet System,” such as the MY LITTLE VALET™ system by Inventive Momma, LLC. In certain aspects of the invention, the Valet System has bodily features of a girl or boy. For example, the top of the system may be in the shape of a girl's face or a boy's face. The front of the face may optionally have a mirror. In some embodiments of the invention, the mirror is at the height of a child's face, e.g., proportionate to a child. The middle portion of the Valet System may be designed to look like a girl's outfit or a boy's outfit. The system acts as a storage and organizational unit for various articles of children's clothing, accessories, and toys.

The Valet System has various hooks, bars, shelves, drawers, cabinets, hooks, clips, and pegs. For example, the front of the system may have clips or bars or hooks to hold a child's pants, shirt, dress, or skirt. The front of the system may also have a fixed or cascading hanger system.

In some embodiments, the head portion of the system may be removable and interchangeable with a shelf and/or tray. In other embodiments the head portion is permanently fixed on the system. The color of the hair on the head portion may be a color such as yellow, brown, black, red.

The Valet System may further comprise a power connection, which functions to receive electrical power from an existing (e.g., household) power outlet. In some embodiments, the power connection may be incorporated within the base of the assembly. The Valet System may be pre-wired for items such as telephone jacks, speaker wires, USB charging outlets, and power outlets. In some embodiments, the Valet System is pre-wired for speaker wires and speakers are incorporated into the system.

The Valet System may be constructed of wood and have a natural stain finish. In other embodiments, the Valet System is constructed of wood and has colored laminate finishes. In other embodiments, the Valet System is constructed of wood and has painted or printed graphics. Other materials such as lightweight molded plastic materials, metal, stone or various combinations of any of the aforementioned materials may be used in construction of the Valet System.

In some embodiments, the Valet System is relatively inexpensive to manufacture, produce, and distribute. It is a further object of the invention to provide the Valet System manufactured in a variety of sizes.

### BRIEF DESCRIPTION OF THE DRAWINGS

FIG. 1A is a front and partial side perspective view of a female version of the Valet System organizational system. FIG. 1B is a front and partial side perspective view of an additional female version of the Valet System organizational system.

FIG. 2A and 2B are front plan views of a female version of the Valet System organizational system. FIG. 2C is a side plan view of a Valet System organizational system.

FIG. 3A is a front and partial side perspective view of a female version of the Valet System organizational system. FIG. 3B is a rear plan view of a female version of the Valet System organizational system.

FIG. 4A is a front and partial side perspective view of an alternative exemplary embodiment of a Valet System organizational system. FIG. 4B illustrates a rear and partial side perspective view of the alternative exemplary embodiment.

FIG. 5 is a front and partial side perspective view of a male version of the Valet System organizational system.

FIG. 6 is a front plan view of a male version of the Valet System.

FIG. 7 is a front plan view of an additional male version of the Valet System.

FIG. 8 is a side plan view of a male version of the Valet System organizational system.

### DETAILED DESCRIPTION

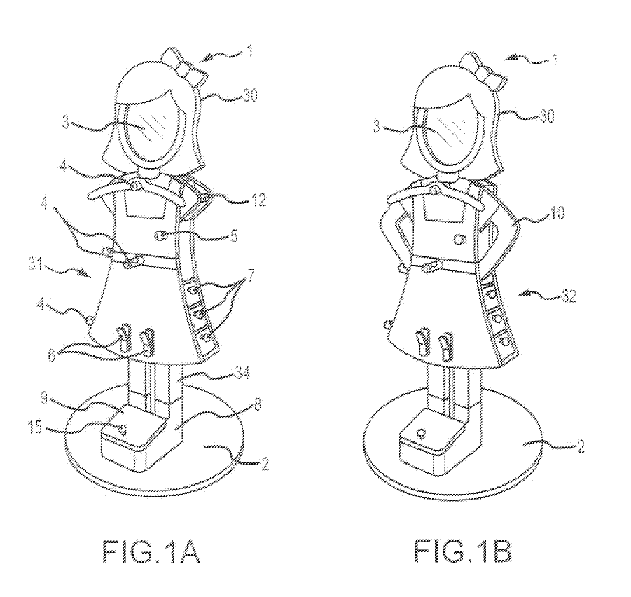

Disclosed herein are children's furniture items. Referring to FIGS. 1-3, a Valet System, indicated generally as 1, is constructed of solid wood, plywood, wood laminate, MDF, particleboard, or other suitable furniture construction materials. The furniture described herein can be used indoors and is sized and dimensioned to fit in a child's bedroom or play room. Varying sized furniture may be used for children of different ages.

FIGS. lA and 1B show two variations of the Valet System 1. The height of the Valet System 1 may be from about 40-60 inches. In some embodiments, the height may be from about 42-58 inches, 44-56 inches, 46-54 inches, 48-54 inches, 50-54 inches, or 52-54 inches. The Valet System 1 comprises a front 31, two sides 32, a base 2, and a back 33 (not shown in FIGS. 1A and 1B). The Valet System 1 further comprises a top part 30, which can be in the shape of a boy's head or a girl's head, and which has a front surface and a back surface. The front surface of top part 30 can be decorated to have hair and accessories appropriate for a boy or girl. For example, as shown in FIGS. 1A and 1B, top part 30 has girl's hair and a hair bow. In some embodiments the hair bow is constructed of wood and is part of the same piece of wood as the hair and face of top part 30. In other embodiments, the hair bow is engineered from a wire form and is attached to top part 30. In other embodiments, top part 30 may be configured to have boy's hair and a baseball cap. The Valet System 1 may be customized and/or personalized for the end-user wherein the hair color on the top part 30 may any of a variety of colors such as blonde, black, brown, red, and the depicted accessories can be adjusted to the customer's liking (e.g., a baseball cap for a favorite team). The top part 30 may further comprise a mirror 3 on the front surface. The height of the Valet System 1 can be selected in order to enable a child to see his or her reflection in the mirror 3. In some embodiments, the Valet System 1 has a telescoping top part 30 that allows the height of the top part 30 to be adjusted.

Below the top part 30, the front 31 of the Valet System 1 is designed to look like a girl's outfit or a boy's outfit. For example, as shown in FIGS. 1A and 1B, the outfit is a girl's shirt and jumper. Other possible outfits include a skirt and shirt, a dress, a bathing suit, and a shirt and shorts. One or more notched bars 4 protrude from the front 31 of the Valet System 1. The notched bars 4 are sized and configured to hold a plurality of clothing hangers (e.g., the hangers can rest in the notches/detents). In other embodiments, the Valet System may comprise one or more fixed hanger or cascading hanger systems. Each notched bar 4 may protrude the same distance from the front 31. In other embodiments, the notched bars 4 extend at different lengths from the front 31. As shown in FIGS. 1A and 1B, the notched bars 4 may be spaced apart so that the bottom of a shirt hanging on the top notched bar 4 hits approximately at the second notched bar 4. In some embodiments, the front 31 may have a notched bar 4 a quarter of the distance from the top of the unit to the bottom and another notched bar 4 at the midway point from the top of the unit to the bottom. In other embodiments, the notched bars 4 are removable and can be placed at a variety of locations. At least one of the two sides 32 may also have a plurality of notched bars 4.

The front 31 of the Valet System 1 may also have a plurality of clips 6 to hold articles of clothing such as skirts, shorts, pants, socks, and tights.

The middle portion of the Valet System 1 may further comprise a cabinet having a door 5 that opens. In some embodiments, the Valet System 1 has arms 10 as shown in FIG. 1B. In other embodiments, instead of arms 10 there are bars 12 as shown in FIG. 1A. The bars 12 may be configured to hold necklaces, baseball hats, bracelets, and other accessories.

The bottom portion of the Valet System 1 is configured to look like two legs 34 and feet 8. The bottom of the feet 8 is attached to the top side of the base 2. In some embodiments, the feet 8 are telescoping and may extend to adjust the overall height of the Valet System 1. The feet 8 may be secured to the base by glue, nails, screws, or other suitable means. In some embodiments, the feet 8 may be hollow and can serve as a receptacle 9 configured to hold a pair of shoes. In such embodiments, the feet 8 may have a lid 15 attached by a hinge or other fastening mechanism to the feet 8 as shown in FIGS. 1A and 1B.

Side 32 may include one or more drawers 7. As shown in FIGS. 1A and 1B, the drawers 7 may extend entirely across the width of the Valet System 1. The width of the drawers 7 may be about 3, 4, 5, 6, 7, or 8 inches. Alternatively, each side 32 can include one or more drawers. Such drawers can extend across the width of the Valet System 1 by any desired distance. For example, the drawers can extend across the entire width of the Valet System 1, with pulls on alternating sides 32. As another example, the drawers can extend only half of the width of the Valet System 1, with pulls on both sides 32.

The base 2 of the Valet System 1 preferably has a diameter of between about 20-30 inches. More preferably the diameter is between about 22-28 inches. Even more preferably the diameter is between about 24-26 inches. The base 2 may have wheels such as recessed rubber caster-wheels (not shown). A plurality of caster wheels may be mounted to the bottom surface of the base 2. In some embodiments, the caster wheels are rubber and recessed so that the base 2 is one half of an inch to one inch above the surface upon which it sits.

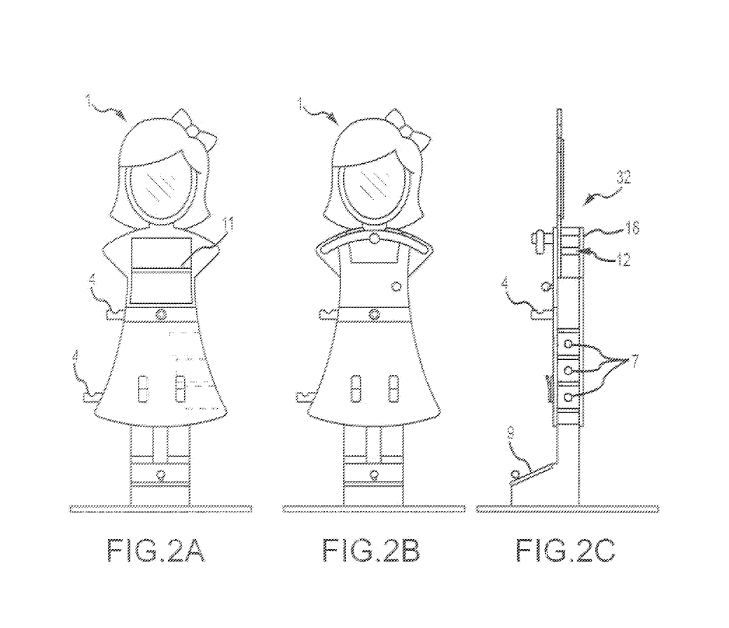

FIGS. 2A-2C illustrate further views of the Valet System 1. FIG. 2A illustrates the interior of the cabinet 5. Cabinet 5 may comprise one or more shelves 11. FIG. 2B shows another view of the front 31 of the Valet System 1.

FIG. 2C is a side view of the Valet System. The example shown in FIG. 2C comprises three drawers 7 having a width of about 3-4 inches. The Valet System 1 may comprise a power connector, which functions to receive electrical power from an existing power outlet, such as a standard household outlet. In some embodiments, the power connector may be incorporated within the base 2 of the assembly. The power connector is connected to a power outlet 18. The power outlet 18 may be a USB charging outlet or an AC outlet such as a NEMA 1-15 socket, NEMA 5-15 socket, or a NEMA 20 A socket. The power outlet 18 may be located on the back 33 of the Valet System 1. The Valet System 1 may also be pre-wired for items such as telephone jacks and speaker wires. In some embodiments, the Valet System is pre-wired for speaker wires and speakers are incorporated into the system. In addition, in some embodiments the Valet System is pre-wired for a lamp and/or nightlight.

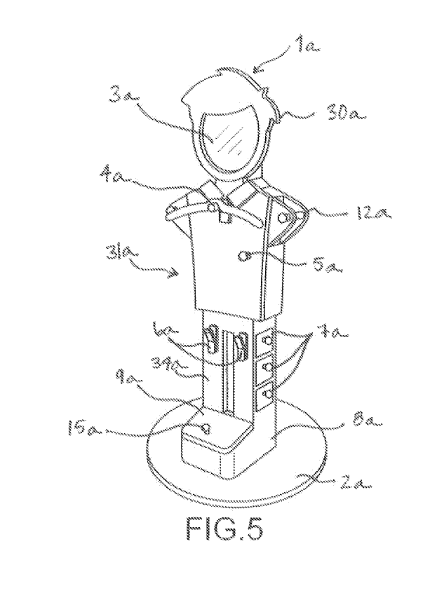

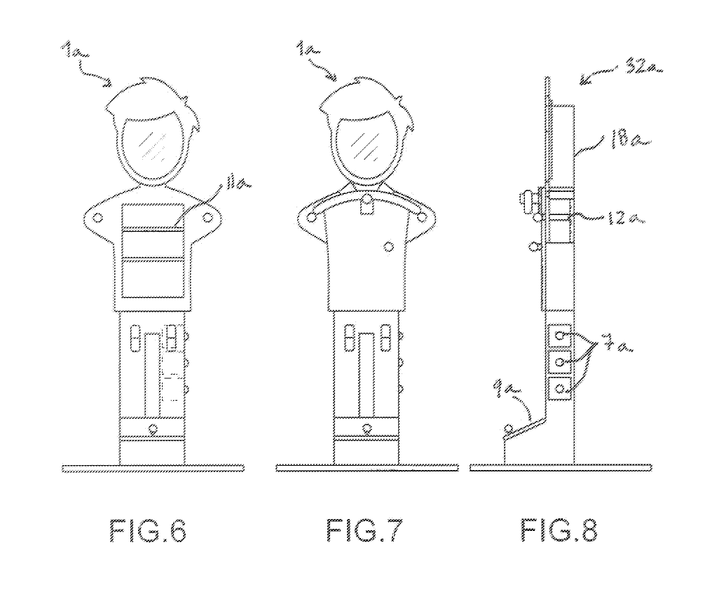

FIGS. 5-8 illustrate a male version of the Valet System 1a with features similar to the female Valet System 1.

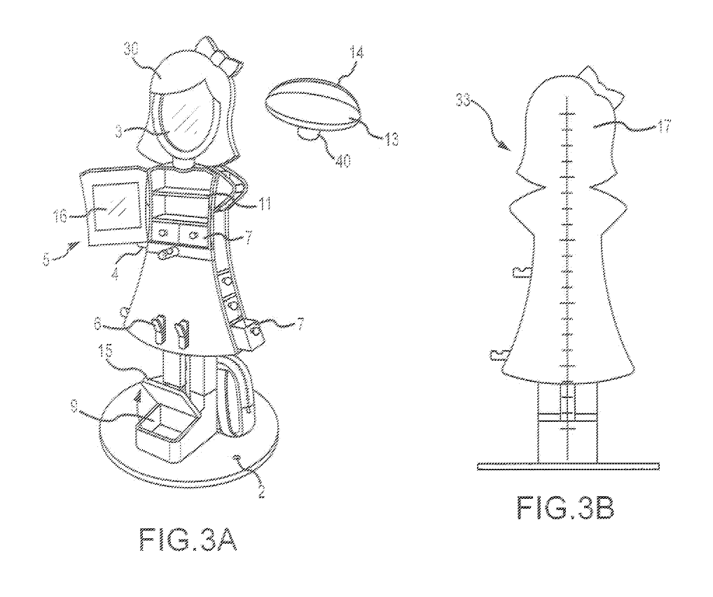

FIGS. 3A and 3B illustrate alternate views of an embodiment of the Valet System 1. In the embodiment shown in FIG. 3A, the top part 30 may be interchangeable with a tray 13. The tray 13 and the top part 30 would each have an appendage 40 that fit within a hollow portion of the Valet System 1. The tray 13 could have any sized shape such as oval, polygonal, circular, square, or rectangular. The tray 13 may further comprise an edge or lip 14.

The embodiment shown in FIG. 3A comprises a door 5. The door 5 has a mirror 16. When the door 5 is open, at least one of two shelves 11 is accessible. When the door 5 is open, drawers 7 may also be accessible.

As shown in FIG. 3B, the back 33 of the Valet System 1 may have a growth chart 17. The surface of the back 33 may be wood, a blackboard finish, a laminate or some other finish that allows both permanent and non-permanent marking with pens, markers, chalk, and other writing instruments. The growth chart 17 may extend from the base 2 of the Valet System 1 to the top of the Valet System 1. The back 33 may also comprise one or more notched bars 4 configured to hold items such as jackets and backpacks. In some embodiments, the back 33 may have a calendar wherein the dates and months can be filled in and changed, e.g., on a blackboard surface or on a dry erase board surface.

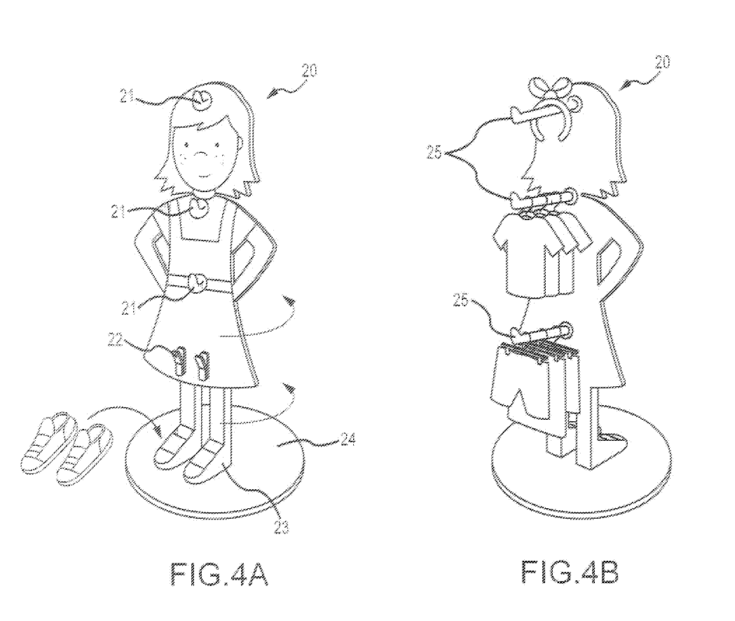

FIGS. 4A and 4B illustrate another version of the Valet System 20. The head, body, and legs portion of the Valet System 20 may be cut from a single piece of solid wood, plywood, wood laminate, MDF, particleboard, or other suitable furniture construction materials. In other embodiments, the Valet System 20 may be formed of molded plastic. An advantage of using molded plastic to make the Valet System 20 is that it is relatively inexpensive to manufacture, produce, and distribute.

As shown in FIG. 4A, the Valet System 20 may have a plurality of hooks 21 on its front side. In other embodiments, the Valet System 20 may have a plurality of notched bars 4. The Valet System 20 may also have a plurality of clips 22 on its front.

The rear of the Valet System 20, shown in FIG. 4B, may have a plurality of bars 25 protruding from the rear surface. The bars 25 are configured to hold a plurality of hangers, necklaces, hats, headbands, and other items, as shown in FIG. 4B.

At the base of the Valet System 20 are feet 23. The feet 23 are secured to the base 24. The feet 23 are configured to have shoes rest on their surface.

It is intended that all matter contained in the above description or shown in the accompanying drawings shall be interpreted as illustrative only and not limiting. It is also intended that features of the individual Valet Systems are interchangeable and may be added or subtracted from additional embodiments. Changes in detail or structure may be made without departing from the spirit of the invention as defined in the appended claims.

What is claimed is:

1. Children's furniture, comprising:
a front, wherein the front is configured to look like a young boy or young girl, the front further comprising a plurality of notched bars and a plurality of clips, wherein the notched bars and clips are configured to hold articles of clothing;
two sides, wherein the first side comprises a plurality of drawers and the second side comprises a plurality of notched bars, wherein the notched bars are configured to hold articles of clothing; and
a back, wherein the back comprises a plurality of notched bars.

2. The children's furniture of claim 1, wherein the front comprises a top part configured to resemble and child's head, a middle portion configured to look like a child's outfit, and legs extending down from the outfit, wherein:
the legs are connected to a receptacle sized to hold a pair of shoes; and
the legs are secured to a base.

3. The children's furniture of claim 1, wherein the furniture comprises a power connection, which functions to receive electrical power from an existing power outlet.
